(19) United States
(12) Patent Application Publication
(10) Pub. No.: US 2025/0045820 A1
(43) Pub. Date: Feb. 6, 2025

(54) SYSTEM AND METHOD FOR CONSISTENCY IN DECISION MAKING

(71) Applicant: BaaS Consultants, LLC, Frisco, TX (US)

(72) Inventor: Praful Mainker, Frisco, TX (US)

(73) Assignee: BaaS Consultants, LLC, Frisco, TX (US)

(21) Appl. No.: 18/364,967

(22) Filed: Aug. 3, 2023

(51) Int. Cl. G06Q 40/03

(52) U.S. Cl. CPC G06Q 40/03

(57) ABSTRACT

One embodiment provides a system, platform, and method for determining inconsistencies. An application associated with a decision is received. The application includes a number of factors associated with the user. A subpopulation most similar to the application is determined. A positive outcome ratio most similar to the application is retrieved. A determination is made whether the decision is consistent with positive outcomes for the subpopulation. A report is automatically generated of inconsistencies associated with the decision in response to determining the decision is not consistent with the positive outcomes for the subpopulation. A report is communication to one or more authorized parties indicating inconsistencies associated with the decision.

### FIELD OF THE INVENTION

The present disclosure relates to providing a unique user interface for providing information, data, and suggestions relating to financial lending and borrowing. More particularly, but not exclusively, the illustrative embodiments relate to a system and method for providing guidance as it relates to fair lending utilizing artificial intelligence. The illustrative embodiments detect, measure, and prevent decisions inconsistencies thereby detecting, measuring and preventing unfair lending practices and other similar risks.

### BACKGROUND

Traditional business, government, and financial services and systems have not succeeded in ensuring that lending practices are completely fair. Fair lending is the process of making consistent loan decisions based on someone's credit worthiness and not their personal characteristics. Potential unfair lending practices have historically failed to best serve protected minorities, geographic locations, and other people at risk despite regulations that govern this area, such as the Federal Housing Act (FHA), Home Mortgage Disclosure Act (HDMA), and Equal Credit Opportunity Act (ECOA). The financial services industry requires mitigation of discrimination risk in its decision process, such as mortgage/loan applications, increases in credit, alternate payment plans in default, and so forth. Discrimination is hard to measure as it involves the intent of the part of the decision maker. As a result, the impact of any process improvements on discrimination is hard to measure and prove. As is well documented, loans and financial products are often not offered or presented to individuals and areas that have been neglected, oppressed, or ignored. As a result, minorities and at-risk individuals often face barriers to accessing financial products, instruments, and services. Similar challenges exist in other industries, such as insurance claim adjudication, criminal justice, college admission, hiring, promotions, and immigration.

### SUMMARY

Therefore, it is a primary object feature, or advantage of the present disclosure to improve over the state of the art.

One embodiment provides a system, platform, and method for determining inconsistencies. An application associated with a decision is received. The application includes a number of factors associated with the user. A subpopulation most similar to the application is determined. A positive outcome ratio most similar to the application is retrieved. A determination is made whether the decision is consistent with positive outcomes for the subpopulation. A report is automatically generated of inconsistencies associated with the decision in response to determining the decision is not consistent with the positive outcomes for the subpopulation. A report is communication to one or more authorized parties indicating inconsistencies associated with the decision. The process may be implemented by a server. In one embodiment, the server includes a processor that executes a set of instructions. The set of instructions are executed to perform the methods herein described.

In another embodiment, public data or private data may be automatically accessed utilizing logic of the server to find the subpopulation similar to the application utilizing the factors. The logic may include at least artificial intelligence configured to implement one or more models associated with the application. The process of determining inconsistencies is performed completely autonomously utilizing at least an artificial intelligence engine. The report may indicate whether anomalies or disparities exist in past decisions when considering the decision. Disparities between the decision and the positive outcomes for the subpopulation may be determined. The decision may be a current decision, proposed decision, or one or more past decisions. One or more narratives associated with the inconsistencies may be automatically generated. User interfaces may be presented allowing the user to filter data associated with the application, the factors, the subpopulation, the positive outcome ratio, and the inconsistencies. The user interfaces may present narratives and summaries regarding results. The report may include at least suggestions to remove the inconsistencies from the application process.

Another embodiment provides a system and method for determining inconsistencies associated with a business. The system includes electronic devices executing a data application, the data application is configured to receive an application associated with a consumer and a decision associated with the application. The system further includes a platform accessible by the electronic devices, the platform receives the application associated with a decision for the consumer, the application includes a plurality of factors associated with a user, determines a subpopulation most similar to the application utilizing, retrieves a positive outcome ratio for the subpopulation most similar to the application, determines whether the decision is consistent with positive outcomes for the subpopulation, automatically generates a report of inconsistencies associated with the decision in response to determining the decision is not consistent with the positive outcomes for the subpopulation, and communicates a report from the platform to the plurality of electronic devices authorized to receive inconsistencies associated with the decision.

One or more of these and/or other objects, features, or advantages of the present disclosure will become apparent from the specification and claims that follow. No single aspect need provide each and every object, feature, or advantage. Different aspects may have different objects, features, or advantages. Therefore, the present disclosure is not to be limited to or by any objects, features, or advantages stated herein.

### BRIEF DESCRIPTION OF THE DRAWINGS

Illustrated aspects of the disclosure are described in detail below with reference to the attached drawing figures, which are incorporated by reference herein.

FIG. 1 is a pictorial representation of a system for determining inconsistencies regarding applications in accordance with an illustrative embodiment.

FIG. 2 further illustrates portions of the system of FIG. 1 in accordance with an illustrative embodiment.

FIG. 3 is a pictorial representation of a system for providing decision consistency information in accordance with an illustrative embodiment.

FIG. 4 is a flow diagram of decision consistency information generated in accordance with an illustrative embodiment.

FIG. 5 is a flowchart of a process for determining decision inconsistencies in accordance with an illustrative embodiment.

FIG. 6 is a flowchart of a process for determining decision consistency in accordance with an illustrative embodiment.

FIG. 7 is a flowchart of a process for improving a process in accordance with an illustrative embodiment.

FIG. 8 is a pictorial representation of a user interface in accordance with an illustrative embodiment.

FIG. 9 is a pictorial representation of a user interface for providing disparity information in accordance with an illustrative embodiment.

FIG. 10 is a pictorial representation of a user interface for anomaly detection in accordance with an illustrative embodiment.

FIG. 11 is a pictorial representation of a user interface for showing similar results for a selected anomalous decision in accordance with an illustrative embodiment.

FIG. 12 is a pictorial representation of a user interface for automatically generating summaries in accordance with an illustrative embodiment.

FIG. 13 is a pictorial representation of a user interface for performing a consistency check in accordance with an illustrative embodiment.

FIGS. 14-21 are pictorial representations user interfaces for showing consistency check results in accordance with an illustrative embodiment.

FIG. 22 is a pictorial representation of a user interface for generating content based on available topics in accordance with an illustrative embodiment.

FIG. 23 is a pictorial representation of a user interface for generating narratives in accordance with an illustrative embodiment.

FIG. 24 is a pictorial representation of a user interface for communicating information to consumers in accordance with an illustrative embodiment.

FIG. 25 is a pictorial representation of a user interface utilized to receive information for performing a consistency check in accordance with an illustrative embodiment.

### DETAILED DESCRIPTION

The illustrative embodiments provide a system, method, and platform that measures and prevents decisions inconsistencies. As a result, the illustrative embodiments detect, measure, and prevent unfair lending practices, processes, and potential decisions while similarly reducing or eliminating other related risks.

In various embodiments, an individual, couple, family, entity, or organization makes a formal request for a decision which is commonly referred to as an application. The application may relate to a loan, credit decision, college admission, court sentencing, probation decision, or other decision, service, or product. The application may provide any number of decision-making factors. For example, for a loan, the decision-making factors may include a credit score, income, expenses, debt, and property details, that may be utilized for the application approval process.

In any decision process the outcome may be classified as a positive or favorable outcome for those submitting an application or a negative or unfavorable outcome where the outcome is not as requested. Some examples are provided below:

| | POSITIVE | NEGATIVE |
|---|---|---|
| | OUTCOME | OUTCOME |
| Lending | APPROVED | DENIED |
| College Admission | ACCEPTED | REJECTED |
| Criminal Justice | EXONERATED | CONVICTED |

The positive outcome ratio is equal to the number of positive outcome/total population and may be expressed as a fraction or a percentage. When comparing two populations of decisions if the positive outcome ratio of one population is higher than the second population, then the second population faces disparity in the decisioning process because the odds against a positive outcome in the second population are higher. Disparity is calculated as the percentage difference of positive outcome ratio from the population with a higher positive outcome ratio.

An example is provided below:

| Applicant | | Positive | Positive | |
|---|---|---|---|---|
| Age Group | Population | Outcomes | Outcome Ratio | Disparity |
| 25-34 | 123,961 | 47,792 | 38.6% | 16.3% |
| 45-54 | 211,699 | 97,688 | 46.14% | 0 |

In circumstances and cases where there are no inconsistencies in decision making, all factors will have the same or very similar ratios and disparities will be very low. In one embodiment, the organization or entity utilizing the system and method may set an acceptable tolerance from the baseline Positive Outcome Ratio to define acceptable level of disparity. As an example, if a lender has an overall Positive Outcome Ratio of 80%, which may be considered the baseline Positive Outcome Ratio, the acceptable range of deviation may be set as +/−10% from the baseline Positive Outcome Ratio.

The illustrative embodiments focus on consistency of decisions rather than only on fairness or unfairness. The described methodology avoids imposing any external constraints on the decision maker so that no bias enters the analytics process. For example, a decision maker, such as a mortgage lender, may be able to do the following utilizing the illustrative embodiments:
a) Examine past decisions to understand factors that show high levels of disparity allowing the decision maker to focus on such areas for improvement.
b) Examine inconsistencies in past decisions from (a) above by comparing past decisions from low disparity and high disparity areas thus helping to identify any steps that may be taken to reduce inconsistencies.
c) Submit a decision as it is made, through the system to test for inconsistency and thus potentially avoid increasing disparity.

The illustrative embodiments may be implemented as an automatic tool. The automatic tool may communicate alerts, specific user interfaces, or other applicable information to eliminate inconsistencies. In one embodiment, the system is not a decisioning model and is intended to better understand what is causing inconsistencies and what steps should be taken to reduce or eliminate inconsistencies. Reduction and eventual elimination of inconsistencies in decisions reduces bias, and hence disparities.

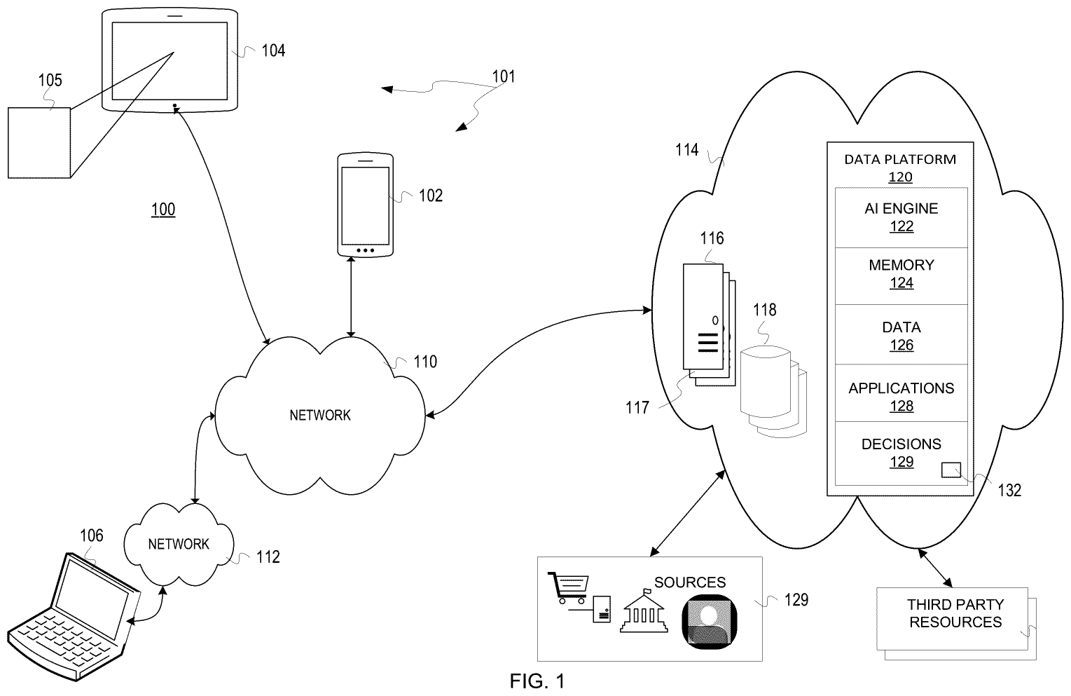

FIG. 1 is a pictorial representation of a system 100 for determining inconsistencies regarding applications in accordance with an illustrative embodiment. In one embodiment, the system 100 of FIG. 1 may include any number of devices 101, networks, components, software, hardware, and so forth. In one example, the system 100 may include a smart phone 102, a tablet 104 displaying a graphical user interface 105, a laptop 106 (altogether devices 101), a network 110, a network 112, a cloud system 114, servers 116, databases 118, a data platform 120 including at least an artificial intelligence (AI) engine 122, a memory 124, data 126, applications 128, and decisions 129. The cloud system 114 may further communicate with sources 130 and third-party resources 131.

Each of the devices, systems, and equipment of the system 100 may include any number of computing, AI/machine learning, and telecommunications components, devices or elements which may include processors, memories, caches, busses, motherboards, chips, traces, wires, pins, circuits, ports, interfaces, cards, converters, adapters, connections, transceivers, displays, antennas, operating systems, kernels, modules, scripts, firmware, sets of instructions, and other similar components and software that are not described herein for purposes of simplicity.

In one embodiment, the system 100 may be utilized by any number of users, organizations, or providers to aggregate, manage, review, analyze, process, display, and/or distribute decisions, information regarding decisions, inconsistencies, disparities, suggestions, feedback, and so forth. In one embodiment, the applications 128 represent data submitted as a process for approval or denial. The applications 128 may be associated with any number of service providers, entities, organizations, governmental groups, management group, decider, or so forth (i.e., decision maker) that operate or access the cloud system 114 and/or the data platform 120 to receive the decisions 129 or inconsistencies 132 regarding the decisions 129. In one embodiment, the system 100 may utilize any number of secure identifiers (e.g., passwords, pin numbers, certificates, etc.), secure channels, connections, or links, virtual private networks, biometrics, or so forth to upload, manage, and secure the goods and services and process applicable transactions.

The devices 101 are representative of multiple devices that may be utilized by businesses or consumers, including consumer, network, and business devices and associated operating systems, programs, sets of instruction, scripts, kernels, and other software, and may also include devices integrated with or utilized by the cloud system 114. The devices 101 may also include personal computers, tablets, touchscreen system, virtual reality/augmented reality devices, gaming devices, e-readers, projection systems, or so forth. The devices 101 utilize any number of applications, browsers, gateways, bridges, or interfaces to communicate with the cloud system 114, data platform 120, and/or associated components.

The wireless device 102, tablet 104, and laptop 106 are examples of common devices that may be utilized to manage available goods and services or perform transactions related thereto.

The devices 101 may communicate wirelessly or through any number of fixed/hardwired connections, networks, signals, protocols, formats, or so forth. In one embodiment, the smart phone 102 is a cell phone that communicates with the network 110 through a 5G connection. The laptop 106 may communicate with the network 112 through an Ethernet, cellular, or Wi-Fi connection.

The cloud system 114 may aggregate, manage, analyze, and process data 126, applications 128, decisions 129, inconsistencies 132, and other content across the Internet and any number of networks, sources 130, and third-party resources 131. For example, the networks 110, 112 may represent any number of public, private, virtual, specialty, or other network types or configurations. The different components of the system 100, including the devices 101 may be configured to communicate using wireless communications, such as Bluetooth, Wi-Fi, or so forth. Alternatively, the devices 101 may communicate utilizing satellite connections, Wi-Fi, 3G, 4G, 5G, 6G, LTE, personal communications systems, DMA wireless networks, and/or hardwired connections, such as fiber optics, T1, cable, high speed trunks, powerline communications, and telephone lines. Any number of communications architectures including client-server, network rings, peer-to-peer, n-tier, application server, mesh networks, fog networks, or other distributed or network system architectures may be utilized. The networks 110, 112 and cloud system 114 of the system 100 may represent a single communication service provider or multiple communications services providers.

The sources 130 may represent any number of company web servers, distribution services (e.g., text, email, video, etc.), media servers, platforms, distribution devices, or so forth. In one embodiment, the sources 130 may represent the businesses, individuals, organizations, or users that utilize the cloud system 114 to perform additional analysis for their data 126, applications 128, decisions 129, and inconsistencies 132. In one embodiment, the sources 130 may have a separate or independent process for processing their data and applications to determine whether there are inherent bias or systematic failures in how the source processes data for their clients or potential clients. The cloud system 114 (or alternatively the cloud network) including the data platform 120 is specially configured to perform the illustrative embodiments. The sources 130 may also represent public servers, databases, social media networks or other services or content that may be accessed utilizing applications, browsers, or software on the devices 101.

The cloud system 114 or network represents a cloud computing environment and network utilized to aggregate, process, manage, analyze, and report on the data 126, applications 128, decisions 129, and consistencies 132. The cloud system 114 allows data 126 to be analyzed in a central location for efficiency. In addition, the cloud system 114 may remotely manage configuration, software, and computation resources for the devices of the system 100, such as devices 101. The cloud system 114 may prevent unauthorized access to data, tools, and resources stored in the servers 116, databases 118, and well as any number of associated secured connections, virtual resources, modules, applications, components, devices, or so forth. In addition, a business may more quickly upload, aggregate, process, manage, and distribute the data 126, applications 128, decisions 129, and inconsistencies 132 utilizing the cloud resources of the cloud system 114 and data platform 120. In addition, the cloud system 114 facilitates distribution of information and data associated with the inconsistencies 132.

The cloud system 114 allows the overall system 100 to be scalable for quickly adding and removing businesses, users, algorithms, models, analysis modules, moderators, programs, scripts, filters, transaction processes, distribution partners, or other users, devices, processes, or resources. Communications with the cloud system 114 may utilize encryption, secure tunnels, handshakes, secure identifiers (e.g., passwords, pins, keys, scripts, biometrics, etc.), firewalls, specialized software modules, or other data security systems and methodologies as are known in the art.

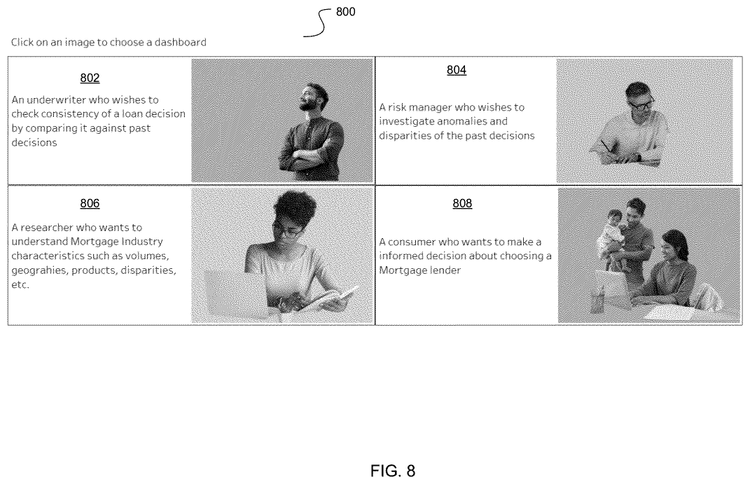

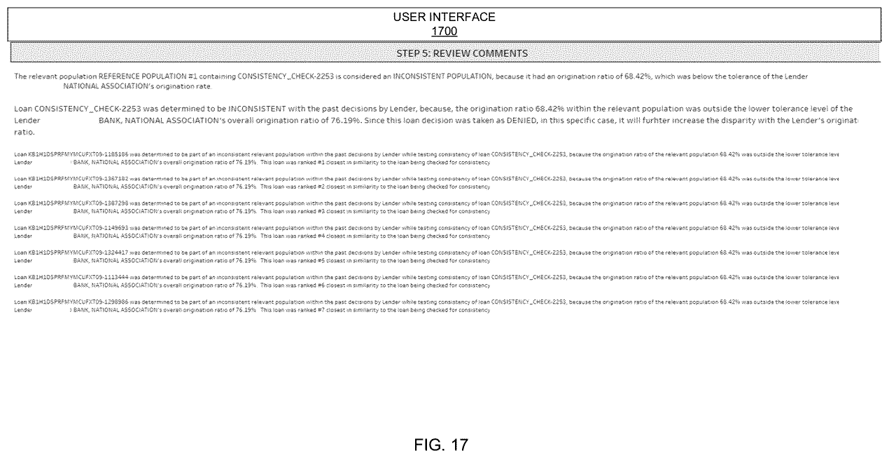

The servers 116 and databases 118 may represent a portion of the data platform 120. In one embodiment, the servers 116 may include a web server 117 utilized to provide a website and user interface (e.g., user interface 105) for interfacing with numerous users (see for example FIGS. 8-25). Information received by the web server 117 may be managed by the data platform 120 managing the servers 116 and associated databases 118. For example, the web server 117 may communicate with the database 118 to respond to read and write requests. The databases 118 may utilize any number of database architectures and database management systems (DBMS) as are known in the art. The databases 118 may store the data and information associated with the data platform 120, such as data 126, applications 128, decisions 129, and inconsistencies 132. The database 118 may also store information relating to individuals associated with the applications 128.

In one embodiment, the user interface 105 is a portion of an inconsistency application (not shown) executed by the devices 101 to interface with the cloud system 114. For example, the user interface 105 may represent the portion of the data platform 120 visible to the user for communicating and receiving information, data 126, applications 128, decisions 129, and inconsistencies 132. The user interface 105 may be made available through the various devices 101 of the system 100. In one embodiment, the user interface 105 represents a graphical user interface, audio interface, or other interface that may be utilized to communicate, display, receive, and otherwise manage data and information. For example, the user may show inconsistencies when comparing a new decision with historical decisions utilizing the user interface 105. The user interface 105 may utilizer any number of windows, icons, drop-down menus, graphics, images, and content. The graphical user interface 105 may be presented based on execution of one or more applications, browsers, kernels, modules, scripts, operating systems, or specialized software that is executed by one of the respective devices 101. The user interface may display current and historical data as well as anticipated future trends. The user interface 105 may be utilized to set the user preferences, parameters, and configurations of the devices 101 as well as upload and manage the content sent to the cloud system 114.

The cloud system 114 and the data platform 120 may manage communications with the devices 101. The data platform 120 may include one or more devices networked to manage the cloud network and system 114. For example, the data platform 120 may include any number of servers, routers, switches, or advanced intelligent network devices. For example, the data platform 120 may represent one or more web servers that performs the processes and methods herein described.

The AI engine 122 is the hardware, software, firmware, and other components and portions of the data platform 120 utilized to implement specialized artificial intelligence and machine learning. The AI engine 122 may include any number of central processing units (CPUs), graphic processing engines, and other equipment. Any number of tensor cores, cards, transformation engines, architectures, accelerators, libraries, and platforms may be implemented in or accessed by the AI engine 122. Portions of the cloud system 114 or data platform 120 may communicate remotely to implement the processes herein described. The AI engine 122 may also be configured to distribute the workload of processing the uploaded data 126, applications 128, decisions 129, and inconsistencies 132. Other intelligent network devices may also be utilized within the cloud system 114. AI algorithms may be programmed in commonly available languages such as Python and R, and can be executed in a stand-alone manner or as part of a larger analytics system, network, or workflow.

The AI engine 122 may utilize any number of thresholds, parameters, criteria, algorithms, instructions, or feedback to interact with users and interested parties and to perform other automated processes. The AI engine 122 may represent one or more processors (e.g., central processing units, graphical processing units, etc.). The processor is circuitry or logic enabled to control execution of a program, application, operating system, macro, kernel, or other set of instructions. The processor may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processor may be a single chip or integrated with other computing or communications components.

The memory 124 is a hardware element, device, or recording media configured to store data for subsequent retrieval or access at a later time. The memory 124 may be static or dynamic memory. The memory 124 may include a hard disk, random access memory, cache, removable media drive, mass storage, or configuration suitable as storage for data, instructions, and information. In one embodiment, the memory 124 and logic engine 122 may be integrated. The memory 124 may use any type of volatile or non-volatile storage techniques and mediums.

In one embodiment, cloud system 114 or the data platform 120 may coordinate the methods and processes described herein as well as software synchronization, communication, and processes. The third-party resources 131 may also represent any number of human or electronic resources utilized by the cloud system 114 including, but not limited to, businesses, entities, organizations, individuals, government databases, private databases, web servers, research services, service providers, and so forth. For example, verification of inconsistencies 132 may be verified through any number of auditing groups, charitable organizations, watchdog groups, or so forth.

The data platform 120 may utilize blockchain as a way to securely store and access the data 126, applications 128, decisions 129, and inconsistencies 132. The data platform 120 may utilized one or more distinct ledgers for different entities, services providers, types of products, users, or so forth. Blockchain systems may be cross-referenced to ensure proper decisions 129 are being made and implemented. The illustrative embodiments provide a system 100, cloud system 114, and data platform 120 for compiling businesses that support causes and documenting consumer transactions that support those causes.

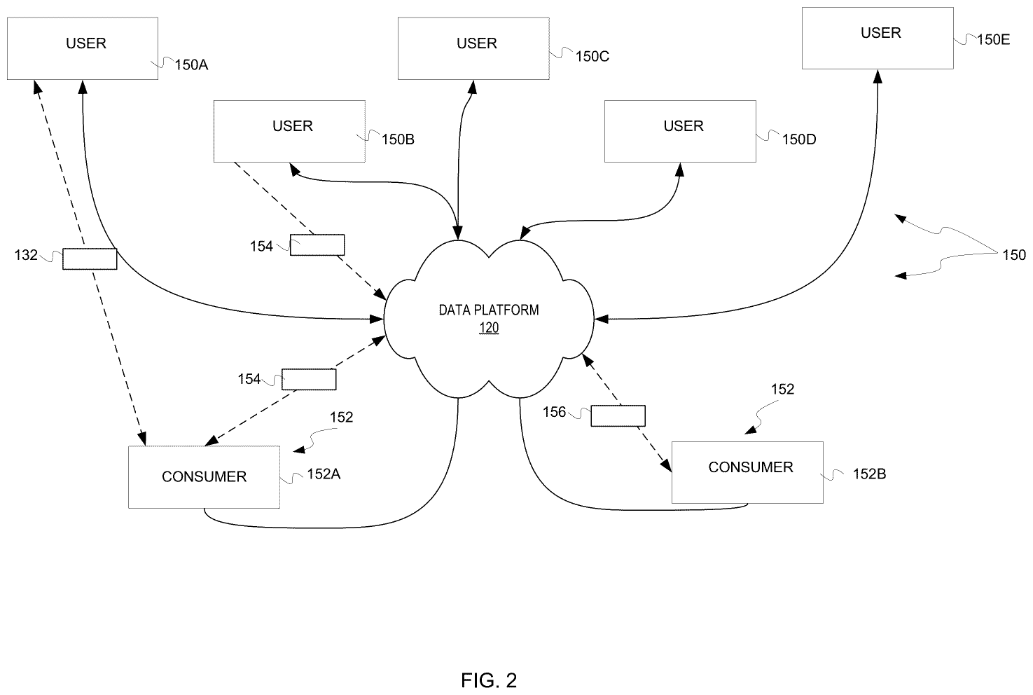

In one embodiment, the data platform 120 may be utilized to verify decisions 129 are consistent. The data platform 120 may utilize an application or application eco system utilized by the devices 101 to automatically determine and retrieve the data 126, applications 128, decisions 129, and inconsistencies 132. In one embodiment, an initial account setup process may be utilized by the users. Thereafter, information may be automatically retrieved from systems, devices, accounts, services, programs, operating systems or other hardware or software devices or interfaces utilized by the users (see the devices of FIGS. 1 and 2).

The third-party resources 131 may represent any number of electronic or other resources that may be accessed to perform the processes herein described. For example, the third-party resources 131 may represent government, private, and charitable servers, databases, websites, services, and so forth for verifying charitable contributions. In another example, auditors may verify information provided by businesses with regard to the causes 128 associated with the businesses themselves or their associated goods and services 126.

In one embodiment, the data platform 120 may distribute electronic (e.g., in-application messages, email messages, text messages, etc.) and/or print notifications and messages to the user and users. For example, user may be notified if decisions 129 have inconsistencies 132.

FIG. 2 further illustrates portions of the system 100 of FIG. 1 in accordance with an illustrative embodiment. As shown the users 150A-E (jointly users 150) may represent the sources 130 of FIG. 1. The users 150 may represent any number of businesses, retailers, service providers, individuals, organizations, entities, or so forth referred to as users 150 or businesses for purposes of simplicity. The consumers 152A, 152B (jointly consumers 152) represent any number of buyers, users, consumers, groups, or individuals that apply for services, admissions, legal treatment, or other actions controlled or managed by the users 150 as performed through, recorded by, or enabled by the data platform 114. In one embodiment, the data platform 120 may represent all or portions of the system 100 of FIG. 1 (including the cloud system 114, servers 116, databases 118). The users 150 may submit applications 154 that are received, aggregated, stored, verified, analyzed, and/or processed by the data platform 120. The users 150 and consumers 152 may represent any number of individuals or groups (e.g., hundreds, thousands, millions, etc.).

As noted, the consumers 150 may send the applications 154 through one or more networks or distribution systems (e.g., electronic networks, brick and mortar stores, etc.), the cloud system 114 of FIG. 1, or directly to the users 150. In one embodiment, the user 150A may distribute a decision or feedback associated with the applications 154 to the consumer 152A through the data platform 120. For example, the data platform 120 may include any number of physical storage, digital storage, warehousing, and distribution systems, facilities, professionals, employees, contractors, electronics, and so forth.

In another embodiment, the user 150A may provide information to the consumer 152A through the data platform 120, but communication of the application 154 and associated decision may occur directly or indirectly through the user 150A and the consumer 152A. For example, the data platform 120 may track or monitor application 154 that are enabled by the data platform 120 to receive a referral fee, payment percentages, royalties/licenses, transaction fees, or other agreed upon payments. In one embodiment, the consumers 152 may utilize the data platform 120 to ensure that their application 154 is processed properly without biases or inconsistencies 132.

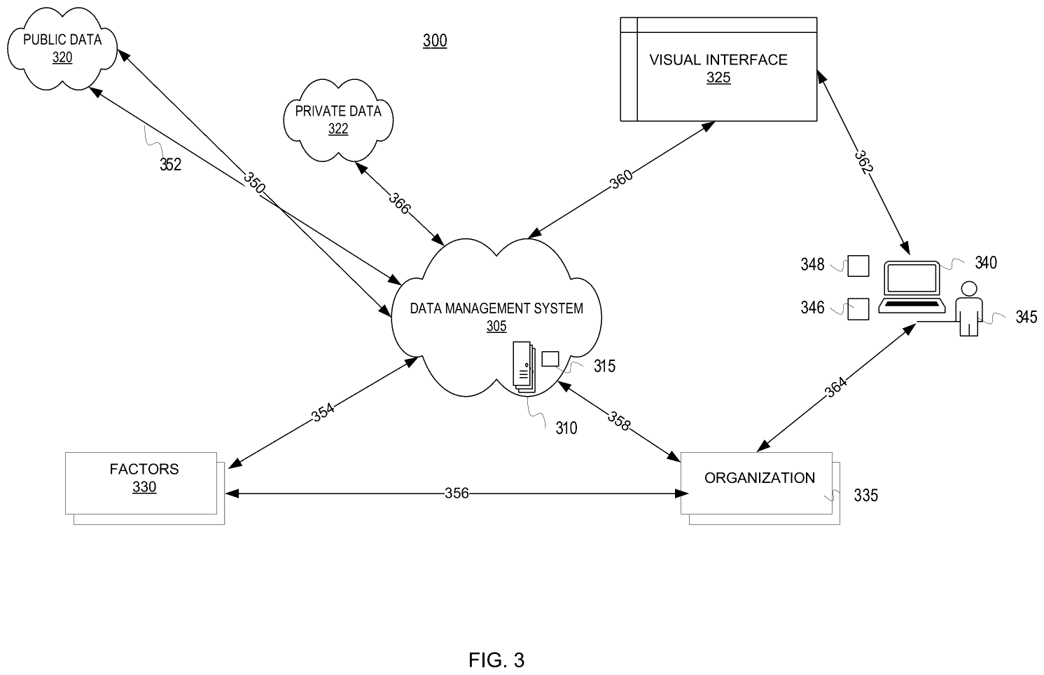

FIG. 3 is a pictorial representation of a system 300 for providing decision consistency information in accordance with an illustrative embodiment. The system 300 may include a data management system 305, servers 310, logic 315, public data 320, a visual interface 325, factors 330, organization 335, computing device 340, and user 345. The system 300 may also implement communications 350, 352, 354, 356, 358, 360, 362, 364.

The data management system 305 is a cloud system/platform configured to manage data flows, artificial intelligence algorithms, machine learning, and other logic. The cloud data management system 305 may also be referred to as a system or platform. For example, the data management system 305 may represent the cloud system 114 of FIG. 1 or other portions of FIGS. 1 and 2.

In one embodiment, the public data 320 may include public mortgage data (e.g., Home Mortgage Disclosure Act (HMDA) data, Community Reinvestment Act (CRA), etc.), census data, property data, criminal background data, or so forth. The public data 320 may also include any number of other types of data. The public data 320 is utilized by the data management system 305 to perform analysis. For example, a current application or decision implemented by the user 345 may be analyzed by the data management system 305. The data management system 305 may utilize Python, Alteryx Servers, Azure Data Factory AWS S3, or so forth.

The communication 350 may represent a manual or automated download from the public data 320 to the data management system 305. In one embodiment, an application program interface (API) of the data management system 305 performs the communication 350.

The organization 335 may represent one or more parties that are authorized to access the data management system 305. The organization 335 may also represent the processed performed by the organization, such as a mortgage or lending underwriting process. The communications 358 may represent data shared as part of reporting processes (e.g., legally required, best practices, etc.).

For example, the organization 335 may share HMDA and CRA data with the data management system 305 for reporting to regulatory agencies.

The factors 330 are the parameters, conditions, information, data, and criteria utilized by the user to make a decision 346 regarding an application 348. The factors 330 are also utilized by the data management system 305 to analyze the decision 346 based on the public data 320 and private data. For financial determinations, the factors 330 may include information, such as product type, debt-to-income ratio, loan to value ratio, income, loan amount, and so forth. The factors 330 may also include non-relevant, but still important demographic information, such as race, ethnicity, gender, age, location, and so forth. The non-relevant information may be utilized to ensure that there are not inconsistencies as related to current and past decisions.

The visual interface 325 is utilized to display or communicate information to the user 345 through communications 360. In one embodiment, the visual interface 325 may present a dashboard for accessing and managing the data received, stored, processed/analyzed, generated, and otherwise managed by the data management system 305. The visual interface 325 may be communicated by the data management system 305. In another embodiment, the data management system 305 and the computing device may execute an application that communicates the data, applications, decisions, inconsistencies, and disparities as are herein described. The visual interface 325 may receive communications 360 regarding decision outcome ratios, disparities of decisions, decision inconsistency populations, reference populations for ongoing consistency checks, and narrative summaries.

In one embodiment, the user 345 may represent a risk manager or underwriter. The communications 362 may represent interactions with various results to determine appropriate actions to reduce decision inconsistency based on the information from the data management system 305. In another embodiment, the user 345 may represent a researcher that interacts with various results and data from the data management system 305 to provide additional insights. The researcher may operate independently, as part of a government group, as part of a watchdog, as an auditor of an organization 335, or so forth.

In another embodiment, the system 300 may have access to private data 322. The private data 322 may be confidential or proprietary to the organization 335. The private data 322 may be accessed by communications 366 through any number of secure portals, APIs, downloads, or so forth. The private data 322 may be utilized by the data management system 305 to provide additional information regarding a decision 346 based on an application 348.

In another embodiment, the user 345 may be a consumer (e.g., mortgage borrower, loan requestor, etc.). The user 345 may submit the application 348 to organization 335 as part of communications 364.

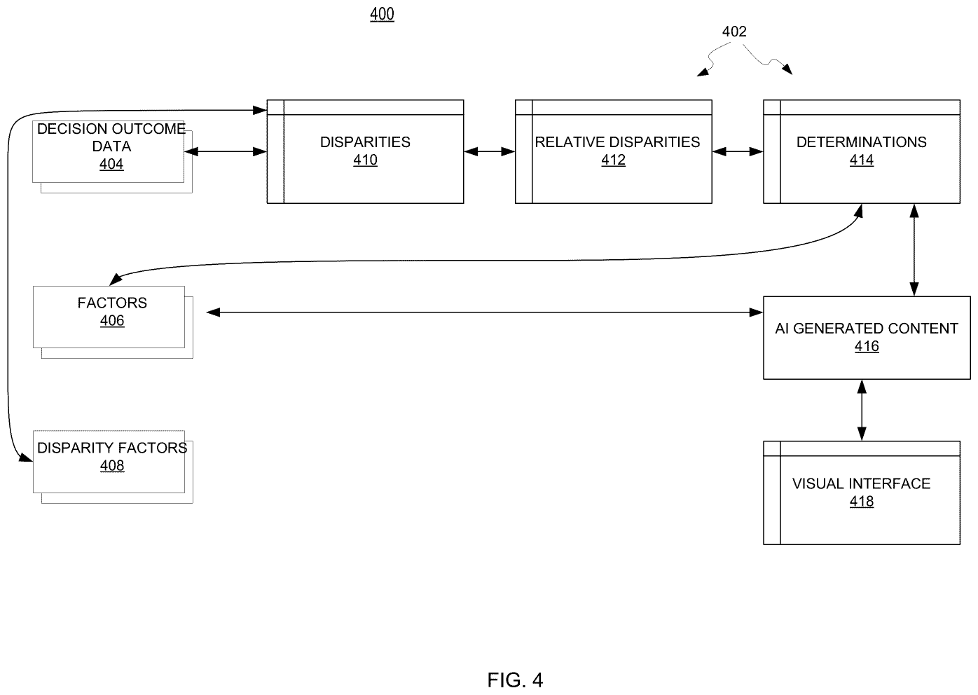

FIG. 4 is a flow diagram 400 of decision consistency information generated in accordance with an illustrative embodiment. The data 402 includes decision outcome data 404, factors 406, and disparity factors 408, disparities 410, relative disparities 412, determinations 414, AI generated content 416, and visual interface 418. All or portions of the data 402 in the flow diagram may be illustrated utilizing the visual interface 418. The visual interface may present any number of graphics, illustrations, windows, tables, data, information, or so forth.

The AI generated content 416 is the artificial intelligence, algorithms, and machine learning content that is processed based on the data 402. The AI generated content 416 may generate the disparities 410, relative disparities 412, and determinations 414 based on the decision outcome data 404, the factors 406, and the disparity factors 408 with the information, data, and content communicated through the visual interface 418. The AI generated content 416 includes a determination of whether a decision is consistent.

The decision outcome data 404 is associated with and combinations of data (e.g., total, partial, subpopulations, private, public, etc.). The AI generated content 416 may utilize AI generated subpopulations most similar to an application to generate determinations 414 whether a decision or potential decision is consistent or whether there are disparities 410. The AI generated content 416 may include text, graphics, data, and narratives that explain whether the decision is consistent or not consistent. The narratives may be an understandable summary of the disparities along with suggestions to correct a process issue, correct the potential decision, or provide suggestions.

The factors 406 are the various criteria, parameters, data fields, and other information, data, and factors utilized to analyze applications and the data 402.

The disparity factors 408 are not utilized in the flow diagram 400 to generate decisions so that no decisions are made or modified based on any prohibited factors.

The disparities 410 may show disparities applicable to one or more applications. The disparities may be based on positive outcome ratios across various disparity factors 408. The disparities 410 may provide key information regarding potential biases and information that needs to be changed. The relative disparities 412 may provide information regarding relative disparities 412 or anomalies based on relevant and non-relevant factors (e.g., race/ethnicity, religion, sex, spoken language, etc.) In one embodiment, the relative disparities 412 may provide information by comparing positive outcome ratios with a baseline, factors 406, or other applicable information by percentage, ratio, graph, table, or so forth. For example, the positive outcome ratios applicable to different races may be showed as a percentage by the relative disparities 412. The disparities 410 may also show volumes of applications by the various factors 406 and geography.

The determinations 414 may communicate subpopulation mix determinations for efficiently identifying anomalies. For example, positive outcomes for factors 406 with low disparities 410 and negative outcomes for factors 406 with high disparities 410.

The visual interface 418 may represent a dashboard or interface windows for users, consumers, or others. The visual interface 418 may display windows, graphics, charts, drop down menus, filters, hyperlinks, scroll wheels, or so forth.

The visual interface 418 may further include an input screen for having an interactive chat based on keywords and phrases. For example, a user may provide key characteristics, such as value of the property, location, income, and FICO score to evaluate decisions (e.g., proposed, decided, historical, etc.). The visual interface 418 may answer questions and give comments about any of the data 402. For example, the visual interface 418 may be utilized by any number of researchers.

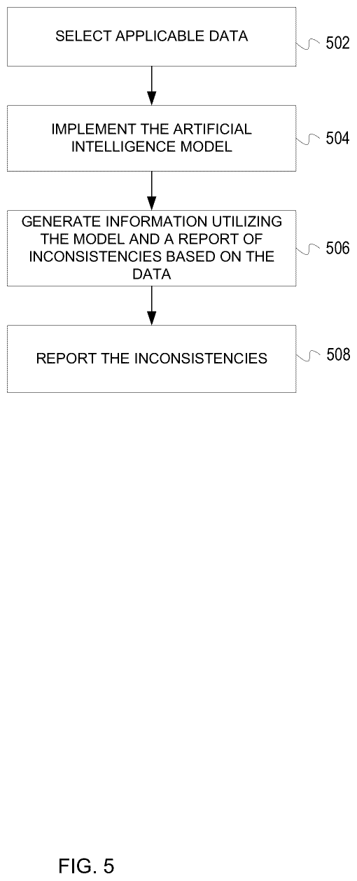

FIG. 5 is a flowchart of a process for determining decision inconsistencies in accordance with an illustrative embodiment. The process may be implemented by a system, platform, or other devices as are herein described. In one embodiment, the user may specify any number user preferences, settings, parameters, criteria, or other information that are utilized by a system to implement the process as herein described. All or portions of the processes or steps described herein may be implemented automatically in response to receiving the data. The process may require minimum user interactions to determine and report inconsistencies as well as potential suggestions. In one embodiment, the processes described herein may be implemented automatically once and application is successfully submitted to be reviewed by a decision-maker (i.e., a corporation, organization, government group, watchdog group, etc.).

The process may begin by selecting applicable data (step 502). The data may represent real, historical, hypothetical, aggregated, combined, or other types of data received from one or more data sources. For example, the applicable data may be received from a single corporation or multiple corporations. The data may be public, private, or a combination thereof. The applicable data may be historical data associated with an organization. The data may be for an individual with comparisons being made against similar applicants (e.g., within the organization, industry, etc.).

In one example, the data or data set of step 502 may be applicable to an application, such as a mortgage application that was approved or denied. The data may include all of the data points that were utilized by the decision maker to make a decision (e.g., credit, property value, debt-to-income ratio, income, etc.).

Next, the system implements the artificial intelligence model (step 504). The system may run the data through one or more models to provide applicable information to the user to update the system. The system may utilize integrated algorithms, logic, AI, machine learning, or may access outside artificial intelligence logic, processing, or other computing resources.

Next, the system generates information utilizing the AI model including at least a report of inconsistencies based on the data (step 506). Embodiment, the system may generate numerous summaries of how the data compares against historical data and the associated actions and decisions that were implemented for the historical data. In one embodiment, the data may be submitted to the system for a consistency check.

Next, the system reports the inconsistencies (step 508). For any specific factor, such as age group, the system shows contrast in past decisions that show inconsistency in decision making without imposing any external constraints or biases into the process. For example, the system may utilize advanced data science techniques, such as unsupervised learning that utilizes machine learning algorithms and AI to analyze and cluster unlabeled datasets. The system may identify past decisions with potential inconsistencies (no matter how large the size of the population) without the need for training any algorithms. The system may then suggest enhancements or modifications to policies utilized by the user or decision maker. This ensures that the model is free of any inadvertent biases coming from the expert opinions, and the results are driven purely by the content of the dataset, and not anyone's definitions, convictions, and/or perceptions,

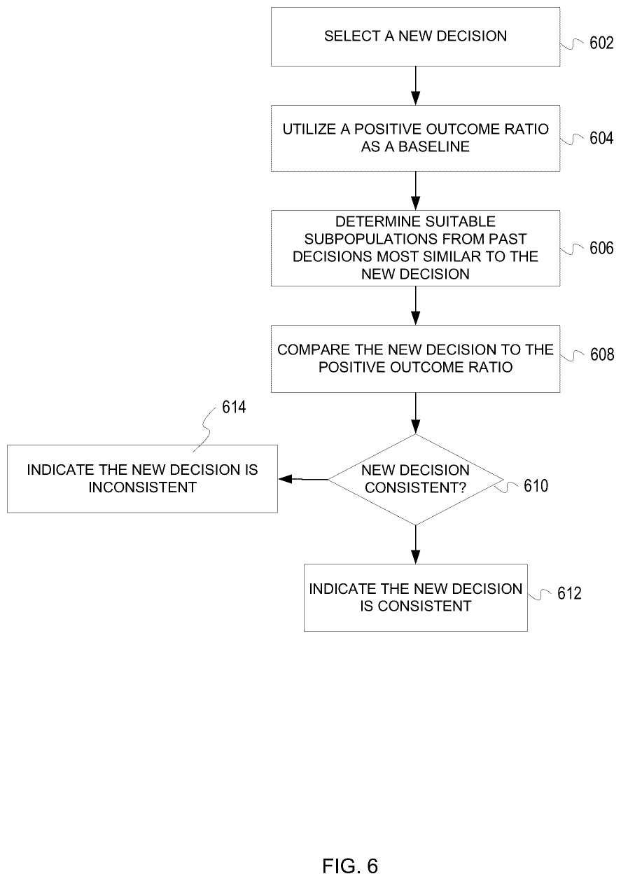

FIG. 6 is a flowchart of a process for determining decision consistency in accordance with an illustrative embodiment. The process may begin by selecting a new decision step (602). The new decision may represent a proposed or tentative decision for the user. For example, the decision may represent a loan decision for a mortgage, car, school loan, home equity loan, or so forth.

Next, the system utilizes the positive outcome ratio of the user as a baseline (step 604). The system utilizes data from the user/decision maker as a baseline so that the new decision may be accurately compared against information and data relevant to the user. The baseline may include a single baseline or numerous baselines based on the breadth of the applicable data. The baseline may be applicable to the subpopulation determined in step 606, all data available, or so forth.

The system utilizes the illustrative embodiments to determine the suitable subpopulations from past decisions most similar to the new decision (step 606). The most suitable subpopulations are those that have the most similar characteristics and factors to those of the new decision.

Next, the system compares the new decision to the positive outcome ratio (step 608). The new decision is compared to the baseline. As a result, the new decision is compared to both positive outcome and negative outcomes associated with the subpopulations of past/historical decisions.

Next, the system determines whether the new decision is consistent (step 610). The system determines whether or not the new decision is consistent based on the subpopulations of similar data and associated past decisions. The system may utilize a specified tolerance to determine whether the new decision is consistent with the positive outcome ratio. In a specific implementation of this invention, the organization or entity managing the system may set an acceptable tolerance from the baseline Positive Outcome Ratio to define acceptable level of disparity.

If the system determines the new decision is consistent in step 610, indicate that the new decision is consistent (step 612). The system may present a user interface or communications detailing how and why the new decision is consistent. If the new decision belongs to a subpopulation that has a positive outcome ratio within a tolerance with the user's overall positive outcome ratio, the new decision may be considered consistent. If the new decision belongs to a subpopulation that has a positive outcome ratio outside of a tolerance with the user's overall positive outcome ration and would decrease disparity, the new decision may be considered consistent.

If the system determines the new decision is inconsistent in step 612, indicate that the new decision is inconsistent (step 614). The system may present a user interface or communications detailing how and why the new decision is inconsistent. For example, if the new decision belongs to a subpopulation that has a positive outcome ratio outside of a tolerance with the user's overall positive outcome ration and would increase disparity, the new decision may be considered inconsistent.

Alternatively, the system may indicate that the new decision could not be effectively evaluated due to a lack of a sufficiently large subpopulation that the new decision belongs to or is otherwise associated with. As a result, additional analysis or comparison may be required to determine if the new decision is consistent.

The following scenarios are shown as examples:

| | | | Subpopu- | |
|---|---|---|---|---|
| | | | lation Positive | |
| Submitted | | | Outcome Ratio | |
| decisions | | Subpopu- | Compared | |
| for con- | | lation | to baseline | CONSISTENCY |
| sistency | | chosen | Positive | CHECK |
| check | Outcome | by AI | Outcome Ratio | RESULT |
| DECI- | Positive | 4,879 | WITHIN | CONSISTENT |
| SION A | | | TOLERANCE | |
| DECI- | Negative | 4,879 | WITHIN | CONSISTENT |
| SION B | | | TOLERANCE | |
| DECI- | Negative | 4,942 | TOO HIGH | INCONSISTENT, |
| SION C | | | | will decrease |
| | | | | disparity |
| DECI- | Positive | 5,007 | TOO LOW | INCONSISTENT, |
| SION D | | | | will decrease |
| | | | | disparity |
| DECI- | Positive | 5,007 | TOO HIGH | INCONSISTENT, |
| SION E | | | | will increase |
| | | | | disparity |
| DECI- | Negative | 4,498 | TOO LOW | INCONSISTENT, |
| SION F | | | | will increase |
| | | | | disparity |

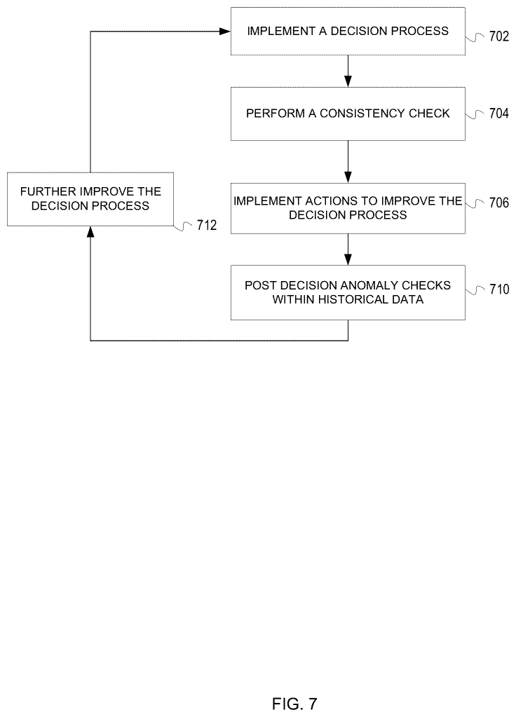

FIG. 7 is a flowchart of a process for improving a process in accordance with an illustrative embodiment. The process may begin by implementing a decision process (step 702). In one embodiment, the process of FIG. 7 may be utilized to improve decision making based on applications that are considered based on various factors.

Next, the system performs a consistency check (step 704). The consistency check may be performed to determine inconsistencies. For example, an application for an applicant may be compared against the positive outcome ratio of a subpopulation most similar to the applicant. Next, the system implements actions to improve the decision process (step 706). Next, the system performs post decision anomaly checks within historical data (step 710).

Next, the system further improves the decision process (step 712).

In one embodiment, a decision maker such as a mortgage application underwriter makes a decision and submits the decision for a consistency check as part of step 702. The system then determines appropriate subpopulations of past decisions and calculates Positive Outcome Ratios for the subpopulations during the consistency check of step 704. The system then compares the subpopulation Positive Outcome Ratios with the baseline Ratio to determine where the decision is consistent in each case, and if not, what would be the effect of such a decision. As a result, the decision-making processes of FIGS. 6 and 7 provide an opportunity for increasing overall consistency of decisions.

FIG. 8 is a pictorial representation of a user interface 800 in accordance with an illustrative embodiment. The user interface 800 may include sections 802, 804, 806, 808. The sections 802, 804, 806, 808 may include selections for various potential users, such as underwriters, risk managers, researchers, and consumers. Alternatively, users may include admissions professionals, judges/lawyers, watchdog groups, government entities, monitors, and other decision makers.

The illustrative embodiments may be implemented for various purposes and users with specific user interfaces presented for each potential user. In one embodiment, a risk manager may utilize the system and method described to investigate potential cases of disparate treatment to propose appropriate actions to remedy the process. For example, if more inconsistencies are found within one geographic area, or product, the process may receive enhanced focus on decision making as it relates to those areas and products. In another embodiment, the underwriters may check decisions or proposed decisions identifying potential process improvements to improve consistency of decision making. In another embodiment, researchers may develop ready to publish articles or research papers to draw attention to potential disparate treatment and needed improvements across an industry. In another embodiment, consumers may make informed decisions on lenders and products for their needs.

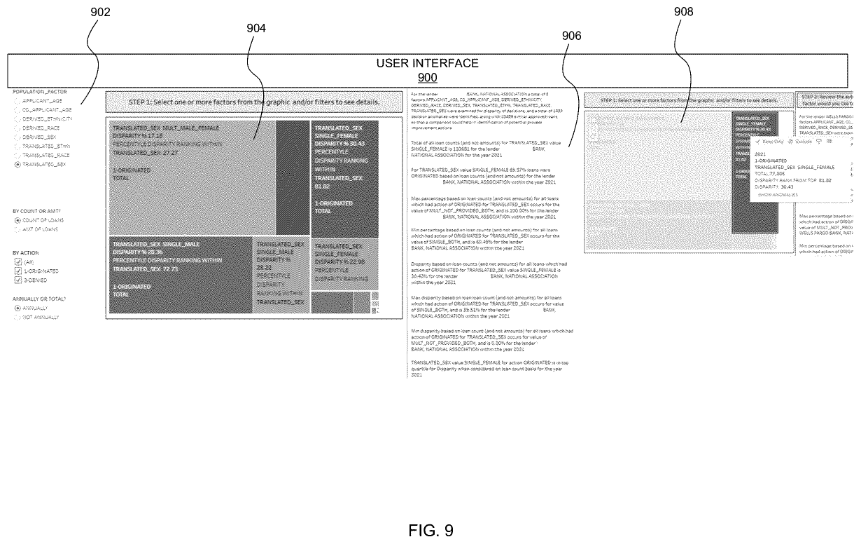

FIG. 9 is a pictorial representation of a user interface 900 for providing disparity information in accordance with an illustrative embodiment. The user interfaces of FIGS. 9-25 may be communicated or displayed visually (e.g., text, data, information, graphics, charts, tables, etc.), audibly, and/or tactilely. Information on the user interfaces may be color coded, patterned, or otherwise marked to distinguish the different types of data. In one embodiment, the user interface 900 may present information for showing disparities based on specific factors, such as age, race ethnicity, gender to further evaluate applications (e.g., loan applications, mortgage applications, admission applications, etc.).

Section 902 allows the user to select population factors, such as age (i.e., application, co-applicant, etc.), ethnicity, race, and sex, count or amount of loans, actions (i.e., all, originated loans, denied loans, etc.), and annual or total applications.

Section 904 may allow the user to visually select to see one or more factors to see additional details.

Section 906 may allow the user to view details based on selections from sections 902 or 904. For example, section 906 may show details that are automatically generated utilizing artificial intelligence based on the selected factors. Section 908 may provide additional filtering information, graphics, and details.

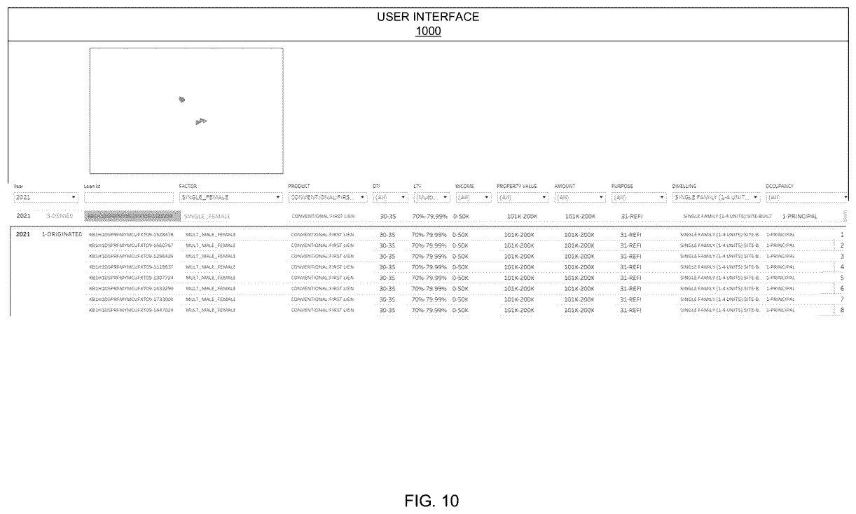

FIG. 10 is a pictorial representation of a user interface 1000 for anomaly detection in accordance with an illustrative embodiment. In one embodiment, a user, such as a risk manager, may review various anomalous decisions against similar loans to determine suitable actions, changes, or revisions to the decisioning process. Similar loans may be presented utilizing artificial intelligence based on similar factors, geography, and so forth.

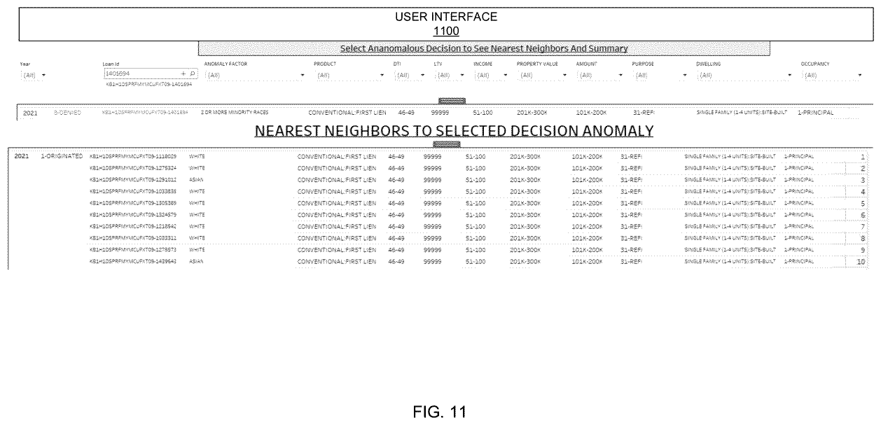

FIG. 11 is a pictorial representation of a user interface 1100 for showing similar results for a selected anomalous decision in accordance with an illustrative embodiment. The user interface 1100 may be utilized to select anomalous decisions and to see the nearest neighbors and summary for loan or mortgage applications.

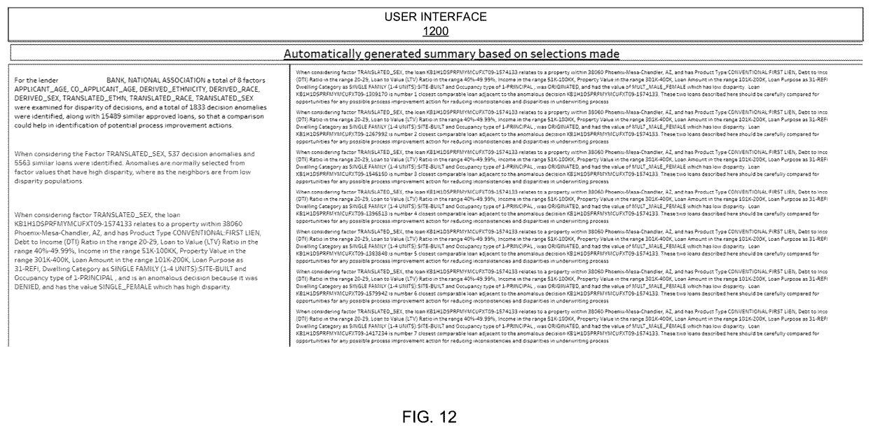

FIG. 12 is a pictorial representation of a user interface 1200 for automatically generating summaries in accordance with an illustrative embodiment. The user interface may be utilized to generate summaries based on one or more selections. The data and information may be automatically generated based on the disparity factors.

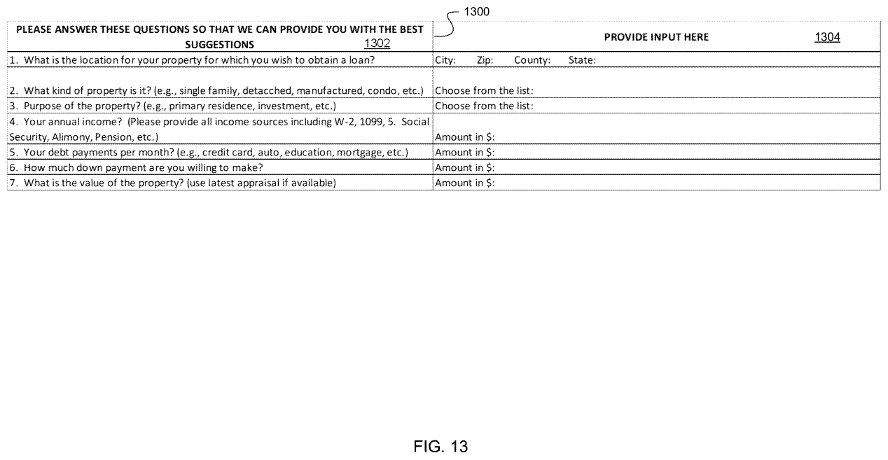

FIG. 13 is a pictorial representation of a user interface 1300 for performing a consistency check in accordance with an illustrative embodiment. The user interface 1300 includes questions 1302 and input 1304. As noted, the questions 1302 may include numerous questions required to perform a consistency check. The input 1304 may be provided utilizing any number of lists from a database or preselected answers, open fields, drop down menus, or so forth.

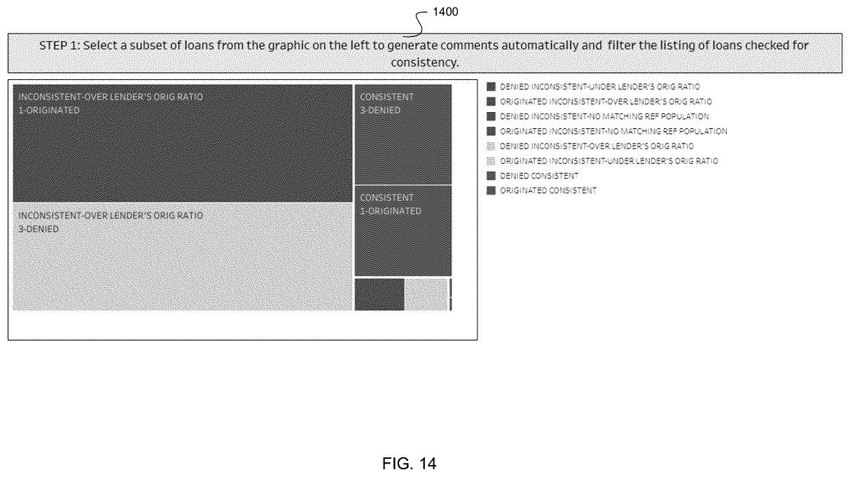

FIGS. 14-21 are pictorial representations user interfaces 1400, 1500, 1600, 1700, 1800, 1900, 2000, 2100 for showing consistency check results in accordance with an illustrative embodiment. The user interface 1400 may allow a user to select a subset of applications (e.g., financial loans) to generate comments automatically and filter the listing of applications for consistency. The results of all consistency checks may be utilized to show likely disparities based on the analysis.

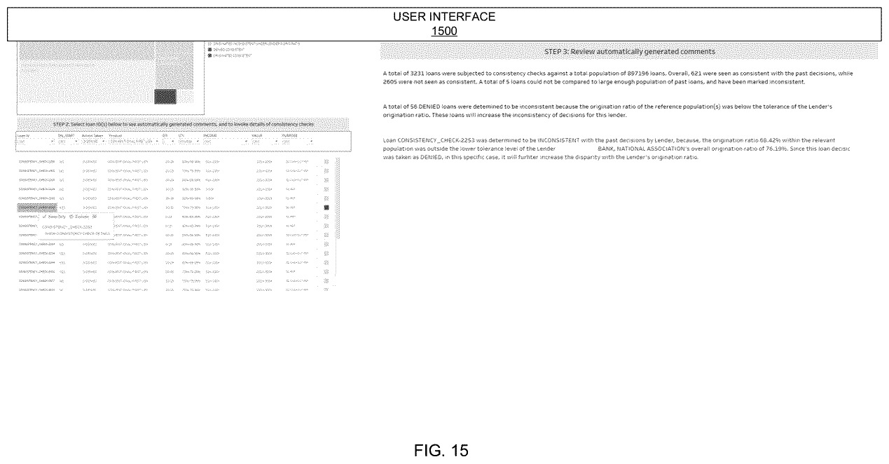

The user interface 1500 of FIG. 15 may be utilized to select a specific loan and the population associated with the application to better understand factors that are leading to inconsistency in the decision. One or more summaries or narratives may be automatically generated for the user interface 1500. Such narratives provide explanation to the user about the data, consistency results, anomalies, and so forth.

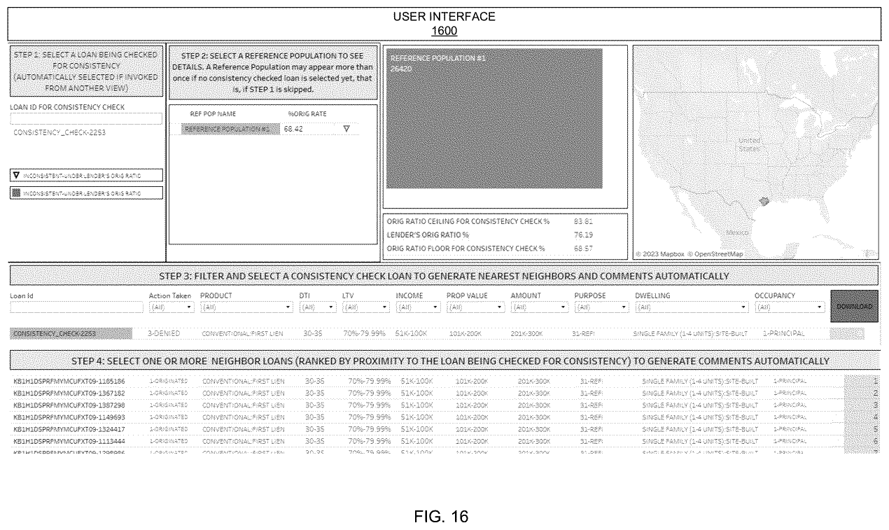

The user interface 1600 of FIG. 16 may allow an application (e.g., loan application) being checked for consistency to see various details utilizing any number of menus, windows, or details.

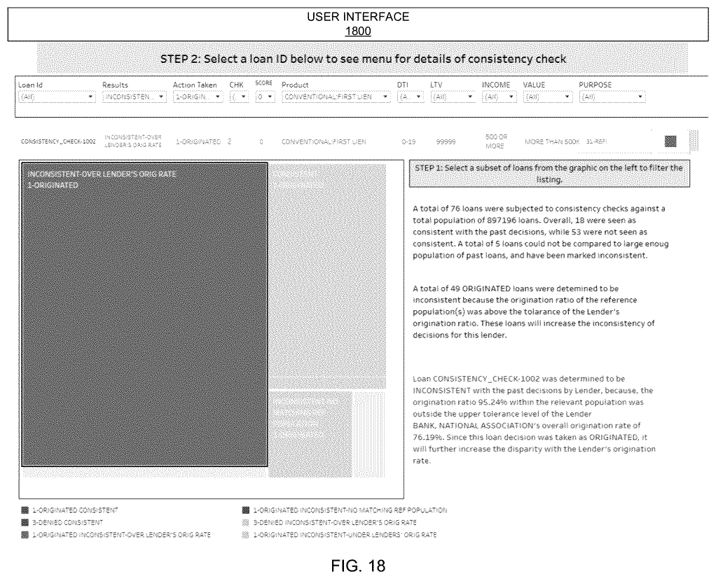

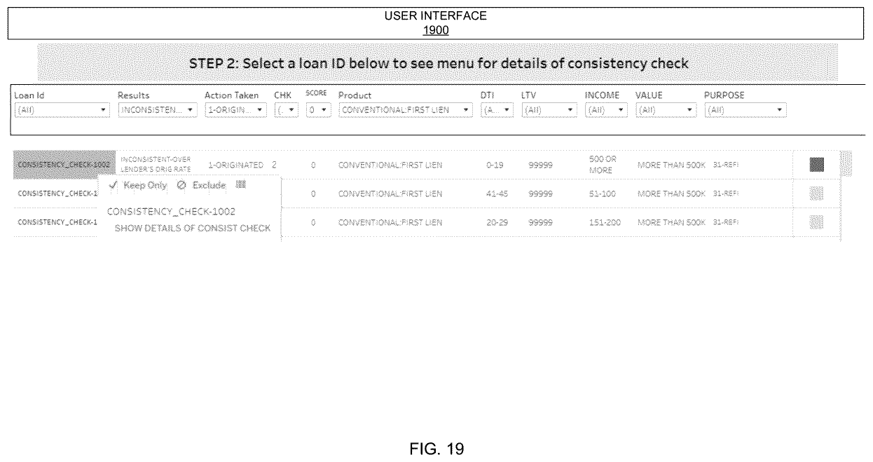

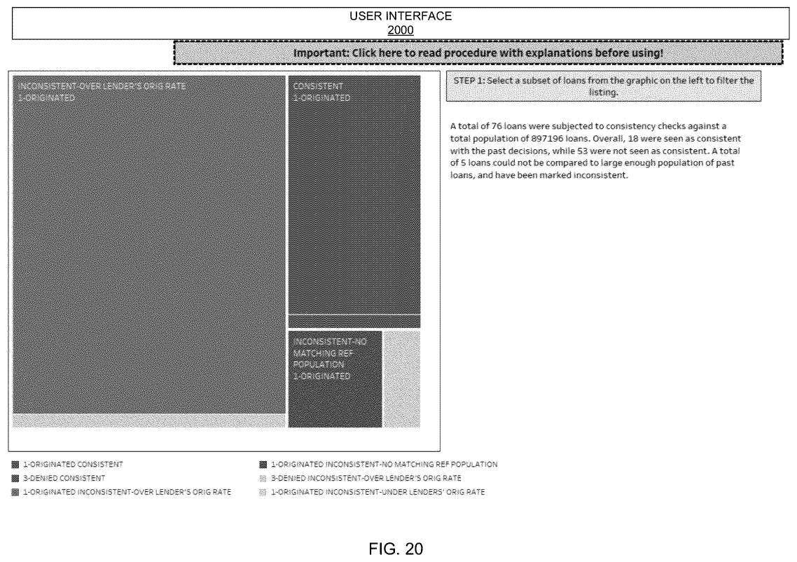

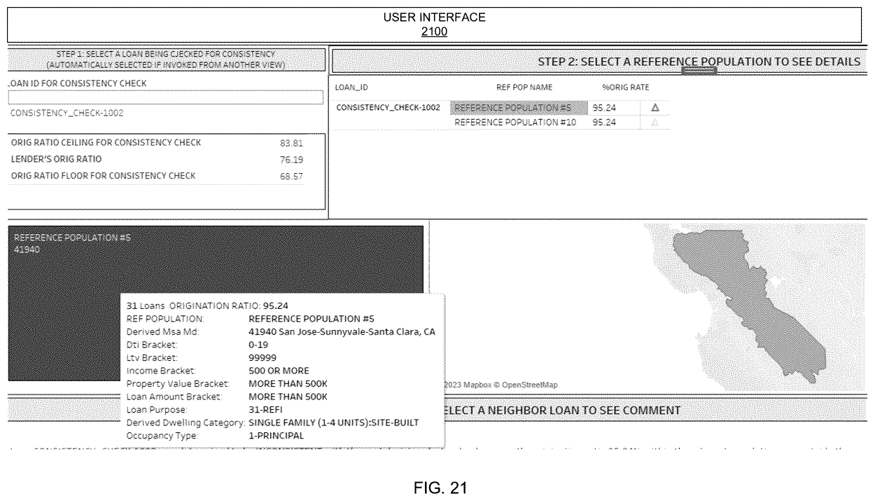

The user interface 1700 shows relative narratives that are automatically produced. The user interface 1800 of FIG. 18 automatically produces narratives for selected subsets or results and for a specific application/decision for consistency. The user interface 1900 of FIG. 19 may be utilized to check for consistency utilizing an identifier, such as a loan identification. The user interface 2000 of FIG. 20 may be utilized to further filter the listings. The user interface 2100 of FIG. 21 may be utilized to view the chosen reference populations/subpopulations with details, such as data (e.g., ratios, percentages, etc.), charts, maps, tables, pop-ups, and so forth.

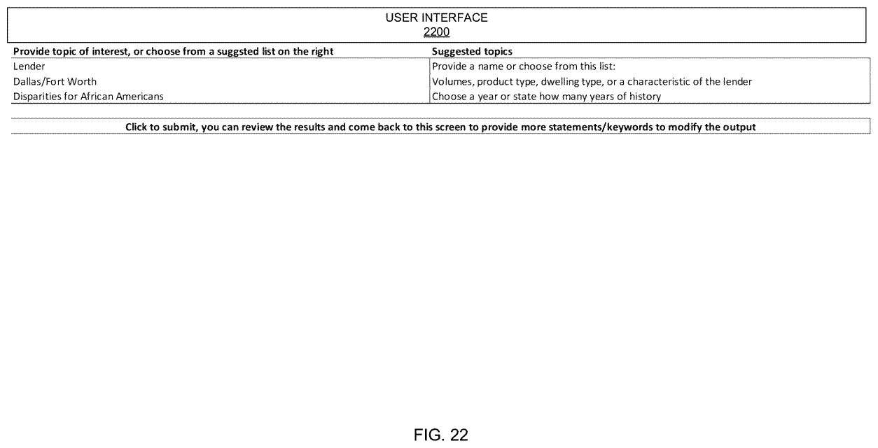

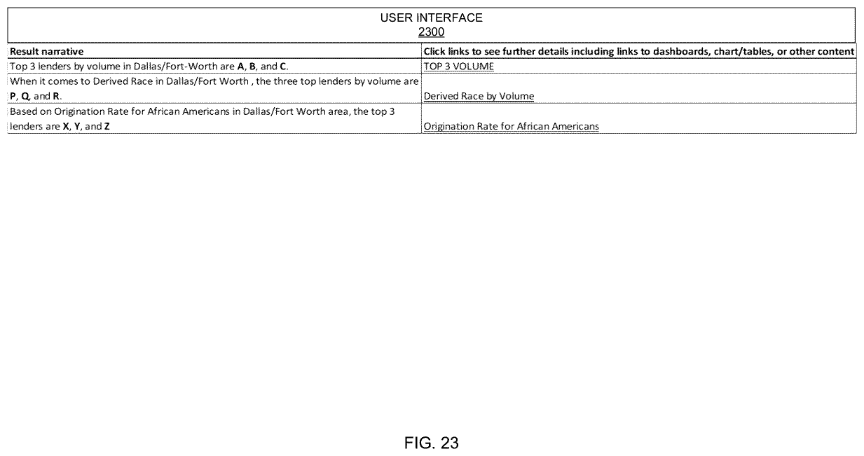

FIG. 22 is a pictorial representation of a user interface 2200 for generating content based on available topics in accordance with an illustrative embodiment. The user interface 2200 (and 2300 of FIG. 23) may be utilized by users, such as researcher, reporters, watchdog groups, or other similar individuals or groups. The user interface 2200 may include topics of interest, such as lender, geographic area, disparities by race, and so forth. The user interface 2200 may also provide suggested topics for reviewing the applicable data.

FIG. 23 is a pictorial representation of a user interface 2300 for generating narratives in accordance with an illustrative embodiment. The user interface 2300 may allow a user to specify a result narrative and then view links, dashboards, charts, tables, or other information.

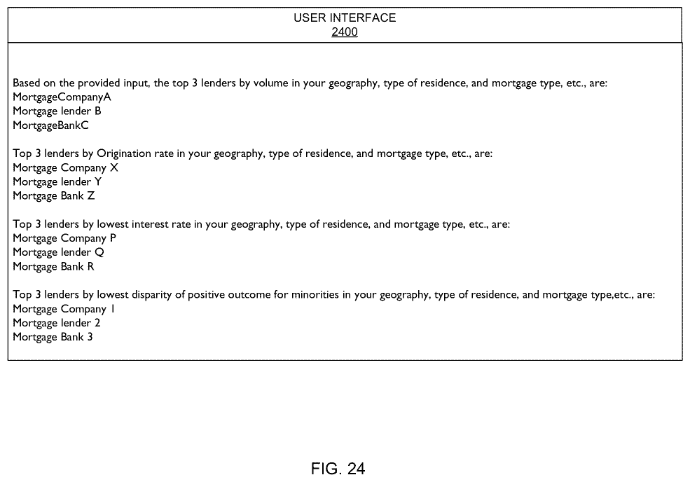

FIG. 24 is a pictorial representation of a user interface 2400 for communicating information to consumers in accordance with an illustrative embodiment. The user interface 2400 may be utilized to provide information regarding applications, such as providers, lenders by origination rate, lowest interest rate by geography, and lowest disparity rate for minorities for a specified location.

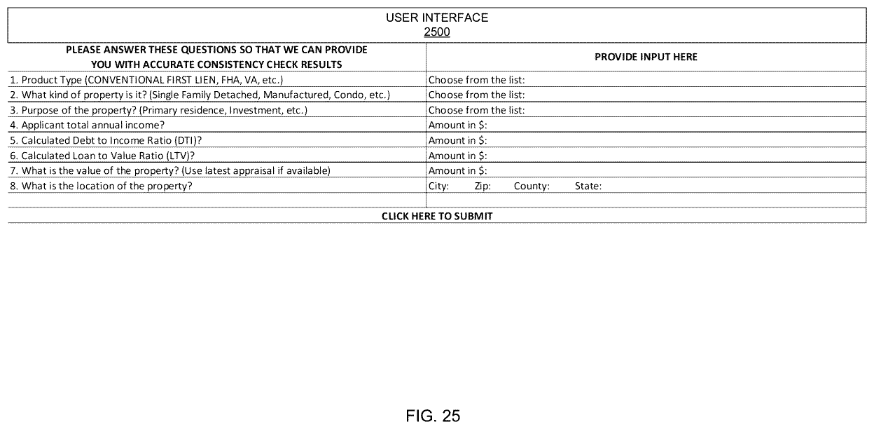

FIG. 25 is a pictorial representation of a user interface 2500 utilized to receive information for performing a consistency check in accordance with an illustrative embodiment. The user interface 2500 may display or communicate any number of questions regarding a product/service, property, applicant, financial status, values, locations, or so forth. The user interface 2500 may also utilize any number of menus, lists, or so forth to provide input.

The illustrative embodiments provide a system, platform, method, and interface system for focusing on inconsistency of decisions. As a result it is possible to detect, measure, and reduce disparity by identifying action that may be taken based on inconsistency within past or historical decisions. He alerts, user interfaces, suggestions, and guidance provided by the illustrative embodiments may be utilized by corporations, entities, regulators, governments/government entities, industries, and other interested parties to protect both individuals, couples, and families as well as the financial providers, service providers, or others (e.g., colleges/schools, insurers, hiring entities, judiciary, etc.).

In one embodiment, it is possible to subject a new decision (e.g., loan/mortgage decision, admission decision, sentencing decision, etc.) to a consistency check and review to determine if any preventative or proactive steps are required by the decision-maker. Reviews and determinations may be particularly important for ensuring consistency and eliminating or reducing disparities. The illustrative embodiments provide an effective way to reduce inconsistency of decisions without bringing any external constraints or biases. The system leverages unsupervised learning utilizing artificial intelligence and machine learn processes utilizing the decision maker's overall positive outcome ratio as a baseline. The illustrative embodiments do not use any prohibited bases, such as race, ethnicity, gender, age, or sexual preference in the classification processes described. The illustrative embodiments, may be applied to fair lending in the financial services industry, insurance policy underwriting, insurance claims adjudication, college admissions, workplace hiring, workplace promotions and terminations, judicial sentencing and probation,

The disclosure is not to be limited to the particular aspects described herein. In particular, the disclosure contemplates numerous variations in System and method for fair borrowing utilizing artificial intelligence. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of aspects, processes or methods of the disclosure. It is understood that any other modifications, substitutions, and/or additions can be made, which are within the intended spirit and scope of the disclosure.

What is claimed is:

1. A method for determining inconsistencies, the method comprising:
receiving an application associated with a decision utilizing a server, the application includes a plurality of factors associated with a user;
determining a subpopulation most similar to the application utilizing logic of the server;
retrieving a positive outcome ratio for the subpopulation most similar to the application;
determining whether the decision is consistent with positive outcomes for the subpopulation;
automatically generating a report of inconsistencies associated with the decision utilizing the server in response to determining the decision is not consistent with the positive outcomes for the subpopulation; and
communicating a report from the server to one or more authorized parties indicating inconsistencies associated with the decision.

2. The method of claim 1, further comprising:
automatically accessing public data or private data utilizing the logic to find the subpopulation most similar to the application utilizing the plurality of factors.

3. The method of claim 1, wherein the logic includes at least artificial intelligence configured to implement one or more models associated with the application.

4. The method of claim 1, wherein the process of determining inconsistencies is performed completely autonomously utilizing at least an artificial intelligence engine.

5. The method of claim 1, wherein the report indicates whether anomalies exist in past decisions when considering disparities of the decision.

6. The method of claim 1, further comprising:
determining disparities between the decision and the positive outcomes for the subpopulation.

7. The method of claim 1, wherein the decision is a current decision, proposed decision, or one or more past decisions.

8. The method of claim 1, further comprising:
automatically generating one or more narratives associated with the inconsistencies.

9. The method of claim 1, further comprising:
presenting a plurality of user interfaces allowing the user to filter data associated with the application, the factors, the subpopulation, the positive outcome ratio, and the inconsistencies.

10. The method of claim 1, wherein the report includes at least suggestions to remove the inconsistencies from the application process.

11. A system for determining inconsistencies associated with a business, comprising:
a plurality of electronic devices executing a data application, the data application is configured to receive an application associated with a consumer and a decision associated with the application;
a platform accessible by the plurality of electronic devices, the platform receives the application associated with a decision for the consumer, the application includes a plurality of factors associated with a user, determines a subpopulation most similar to the application utilizing, retrieves a positive outcome ratio for the subpopulation most similar to the application, determines whether the decision is consistent with positive outcomes for the subpopulation, automatically generates a report of inconsistencies associated with the decision in response to determining the decision is not consistent with the positive outcomes for the subpopulation, and communicates a report from the platform to the plurality of electronic devices authorized to receive inconsistencies associated with the decision.

12. The system of claim 11, further comprising:
one or more databases storing public information associated with the subpopulation including at least applications, factors, and decisions for each user that is part of the subpopulation.

13. The system of claim 12, wherein the platform further:
automatically accesses public data or private data utilizing the logic to find the subpopulations most similar to the application utilizing the plurality of factors; and
automatically generates one or more narratives associated with the inconsistencies.

14. The system of claim 11, wherein the platform includes artificial intelligence that implements models to generate the subpopulation, determination of whether the decision is consistent with the positive outcomes for the subpopulation, the inconsistencies, and the report.

15. The system of claim 11, wherein the inconsistencies indicate one or more discrepancies associated with the factors or non-relevant factors that were not considered in the decision.

16. A platform for determining inconsistencies associated with an application, comprising:
a processor executing a set of instructions;
a memory storing the set of instructions, wherein the instructions are executed to:
receive an application associated with a decision, the application includes a plurality of factors associated with a user,
determine a subpopulation most similar to the application utilizing, retrieves a positive outcome ratio for the subpopulation most similar to the application,
determine whether the decision is consistent with positive outcomes for the subpopulation,
automatically generate a report of inconsistencies associated with the decision in response to determining the decision is not consistent with the positive outcomes for the subpopulation, and
communicates a report from the platform to the plurality of electronic devices authorized to receive inconsistencies associated with the decision.

17. The platform of claim 16, wherein the platform communicates with one or more databases storing public information associated with the subpopulation including at least applications, factors, and decisions for each user that is part of the subpopulation.

18. The platform of claim 16, wherein the platform includes artificial intelligence that implements models to generate the subpopulation, determination of whether the decision is consistent with the positive outcomes for the subpopulation, the inconsistencies, and the report.

19. The platform of claim 16, wherein the inconsistencies indicate one or more discrepancies associated with the factors or non-relevant factors that were not considered in the decision.

20. The platform of claim 16, wherein the report includes at least suggestions to remove the inconsistencies from the application process.
